(19) United States
(12) Patent Application Publication
(10) Pub. No.: US 2010/0238279 A1
(43) Pub. Date: Sep. 23, 2010

(54) Diagnostic Camera and Attachment for the Implementation Thereof

(75) Inventors: Michael Thoms, Bietigheim-Bissingen (DE); Peter Lais, Erligheim (DE)

Correspondence Address: LEMPIA BRAIDWOOD LLC, One North LaSalle Street, CHICAGO, IL, 60602, US

(73) Assignee: Durr Dental AG, Bietigheim-Bissingen (DE)

(21) Appl. No.: 12/531,459

(22) PCT Filed: Mar. 11, 2008
(86) PCT No.: PCT/EP08/01931

§ 371 Date: Dec. 28, 2009

(30) Foreign Application Priority Data
Mar. 16, 2007 (DE) 10 2007 013 355.5

(51) Int. Cl. H04N 7/18

(52) U.S. Cl. 348/77; 348/E07.085

(57) ABSTRACT

An attachment (40, 40a, 40b) for a diagnostic (10) comprises a coupling section (42) configured for the detachable connection to a head region (14) of a diagnostic camera (10), and a dimensionally stable spacer (44) that is connected to said section and has a free end section (46).

The invention relates to a diagnostic camera and also to an attachment for the implementation thereof.

A known dental diagnostic camera is provided for the remote examination of an oral space of a patient. Its housing exhibits a gripping portion and also a slender head region connected to said gripping portion. The gripping portion is provided for the grasping and guiding of the diagnostic camera by a user. The head region, which is located in prolongation of the gripping portion, contains a camera unit with optical and electronic components such as lens optics and an image-recording device.

With the camera unit a greatly magnifiable image of the oral space to be examined or of the teeth can be recorded and relayed in the form of electrical signals to a display instrument, for example a monitor. Owing to the conditions of working (stooped posture, poor direct visual contact with the point of observation), it is difficult to record a sharp and still, non-blurred diagnostic-camera image of the oral space or of the teeth in the oral space.

By virtue of the present invention a way is to be demonstrated in which a stiller image status and good image sharpness is obtained with a diagnostic camera.

In accordance with the invention, this object is achieved by a diagnostic camera according to the features of Claim 1 and by a diagnostic-camera attachment with the features of Claim 13.

The diagnostic camera according to the invention exhibits at least one dimensionally stable spacer with a free end portion which is at least predominantly arranged outside the field of view. By means of the free end portion, an object region defined by the optical components of the diagnostic camera—that is to say, a location region within which an object is sharply imaged by the diagnostic camera—can, when use is made of the diagnostic camera, be made visible to the user and/or made capable of being experienced by the user by tactile means.

By this means, the user can position the diagnostic camera in the oral space at a correct distance from the object to be recorded, in particular a tooth, without for this purpose having to view the monitor—which typically faces towards the patient—on which the image of the object is represented.

The spacer is preferentially configured in such a manner that its free end is arranged in the object plane of the diagnostic camera.

The free end portion of the spacer also predetermines a bearing surface which, for example, may be placed onto the surface of the tooth to be recorded, as a result of which a stabilisation of the diagnostic-camera image recorded by the diagnostic camera is obtained, the object being situated simultaneously in the object plane of the diagnostic camera.

Advantageous further developments of the invention are specified in the dependent claims.

With a diagnostic camera according to Claim 3, the free spacer is designed as an at least substantially full-perimeter sleeve and consequently gives up a bearing surface. As a result, a tilting of the diagnostic camera in relation to the object to be recorded, in particular a tooth, can be kept slight by planar seating of the attachment on the object. As a result, distortions of the image are reduced and the imaging quality for the object is improved.

In a particularly advantageous embodiment of this variant, the free end portion is constructed as a closed, full-perimeter wall, so that a seating of the diagnostic camera on the object to be imaged is guaranteed, irrespective of the orientation of the gripping portion of the camera housing.

The further development of the invention according to Claim 4 is an advantage with regard to a reliable connection between the spacer and the diagnostic camera. In this way, during the utilisation of the diagnostic camera the spacer is prevented from detaching from the head region and falling into the oral space.

With the diagnostic camera according to Claim 5, an advantageous orientation of the end face of the free end portion in the object plane predetermined by the diagnostic camera can be realised. Typically, a diagnostic camera exhibits a direction of view which is tilted (preferentially by 90 degrees) in relation to a central longitudinal axis of the gripping portion of the housing. Hence the free end portion of the likewise angled (preferentially by 90 degrees) channel, which is formed by spacer and coupling portion, is situated at least almost in the object plane.

The further development of the invention according to Claim 6 guarantees that undesirable reflections on the inside of the channel in the region of the spacer, which would impair the image quality, do not occur.

The inside of the channel may, according to Claim 7, exhibit an increased roughness in relation to the otherwise smoothly-produced surfaces of the attachment. For example, the inside of the channel is provided with a mean roughness height R, from 1 μm to 40 μm, preferentially from 2 μm to 10 μm, particularly preferentially less than 4 μm. In supplement, or alternatively, grooves may also have been provided on the inside of the channel, which preferentially run in the peripheral direction, orthogonally relative to the direction of view. The roughness brings about a diffuse scattering of incident rays of light and consequently enables a reduction of reflection.

The diagnostic camera according to Claim 8 enables, by virtue of the preferentially conical or pyramidal widening towards the free end, a compact design of the spacer without the field of view of the diagnostic camera being limited as a result.

The further development of the invention according to Claim 9 guarantees an inexpensive production and also a robust design of the spacer attachment, since the coupling portion and the spacer are produced integrally, in particular in a plastics injection-moulding process.

The attachment is preferentially produced, according to Claim 10, from a sterilisable plastic, for example a polypropylene. Hence reusability can be guaranteed while complying with the disinfection and/or sterilisation regulations in force for medical and dental instruments. In addition, the diagnostic camera can be realised with a low weight.

The diagnostic camera according to Claim 11 is constructed in such a manner that the camera housing and the coupling portion exhibit co-operating latching means. Hence a releasable fastening and a reliable fixing of the spacer attachment to the diagnostic camera can be realised in simple manner.

A spacer attachment according to Claim 13 and dependent claims subordinate thereto permits the aforementioned advantages to be obtained also with diagnostic cameras already in use in this field.

According to the invention, a diagnostic camera is consequently obtained (at the factory or by retrofitting) that enables the diagnostic camera to be placed and supported on the object to be recorded. Hence a low-blur or blur-free image of the object can be achieved. In the case of construction from plastic, in addition to a favourable production cost a secure, preferentially positive and hence precise and secure support of the spacer attachment on the head region of the diagnostic camera is guaranteed. The elasticity properties of the plastic material make it possible to avoid injuries to the gingiva or to the mucous membrane of the mouth also in the case of thin-walled design of the spacer attachment, since no hard edges rest on the tooth or come into contact with the gingiva.

The invention will be elucidated in more detail below on the basis of exemplary embodiments with reference to the drawings. Shown therein are:

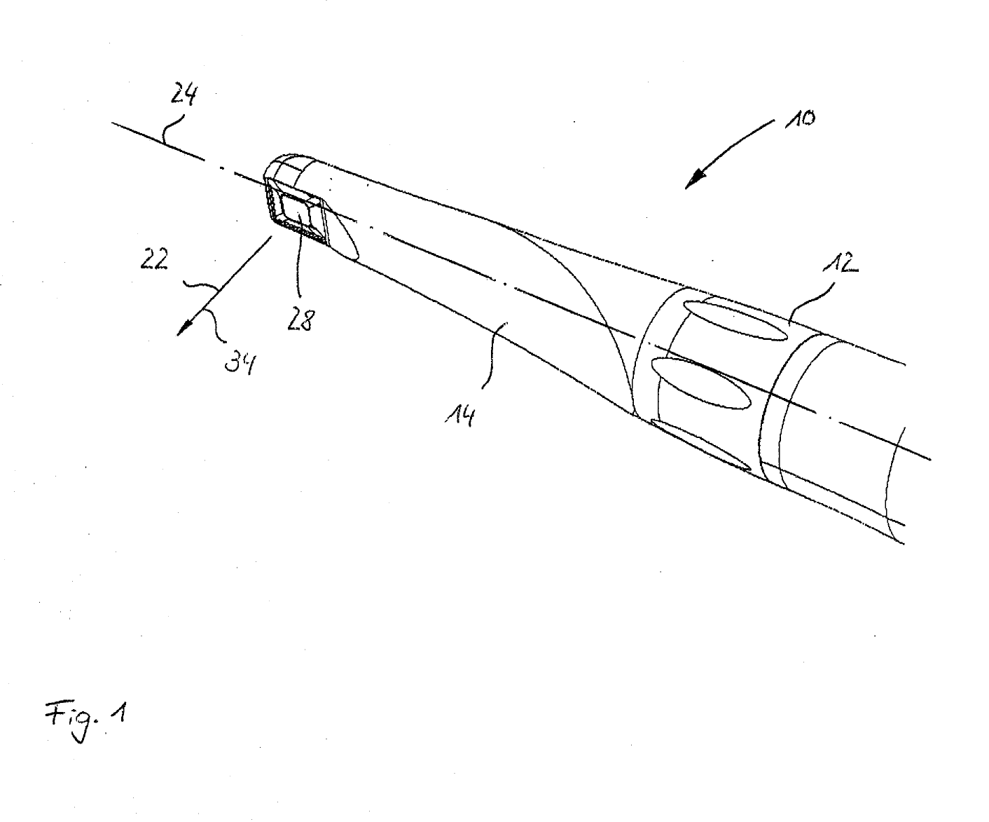

FIG. 1 a perspective representation of a dental diagnostic camera with a gripping portion and with a head region;

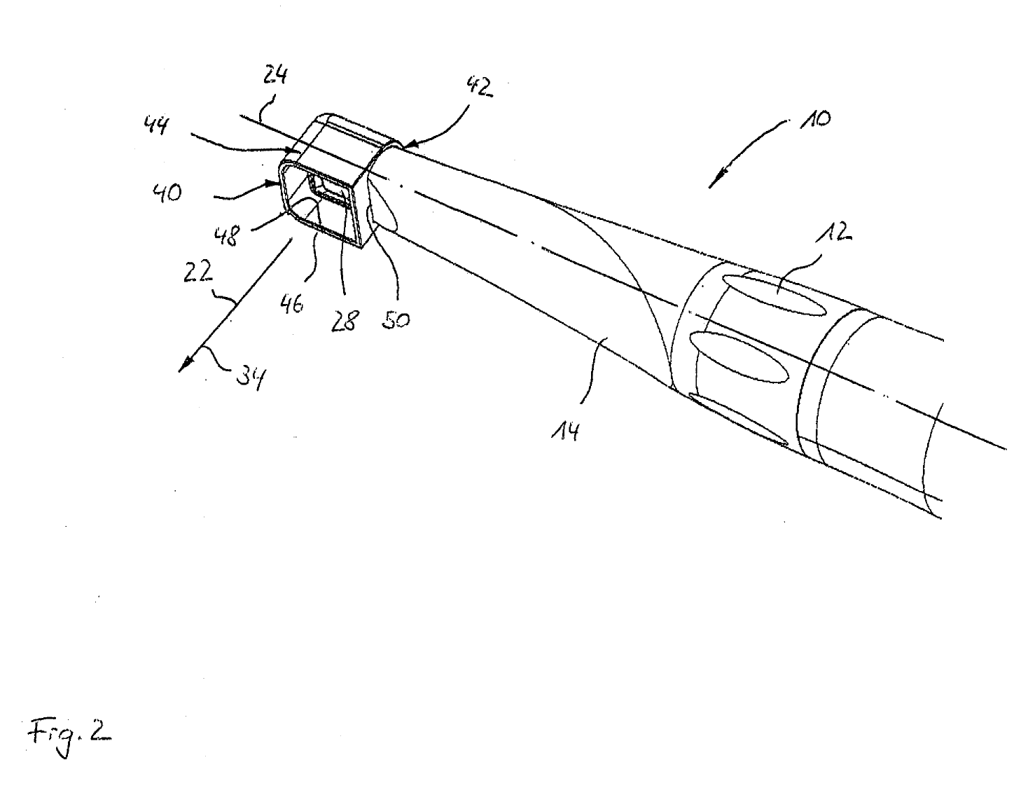

FIG. 2 a perspective representation of the dental diagnostic camera according to FIG. 1 with a spacer attachment;

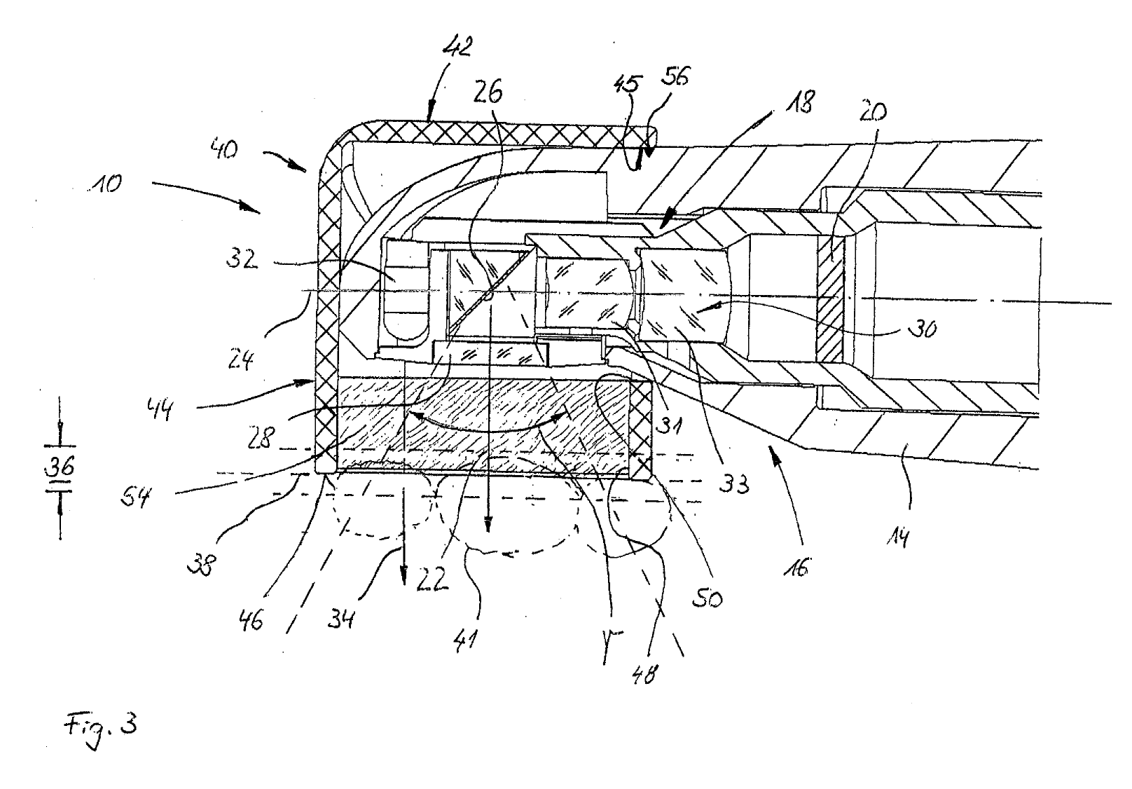

FIG. 3 a sectional representation of the head region of the dental diagnostic camera according to FIG. 2;

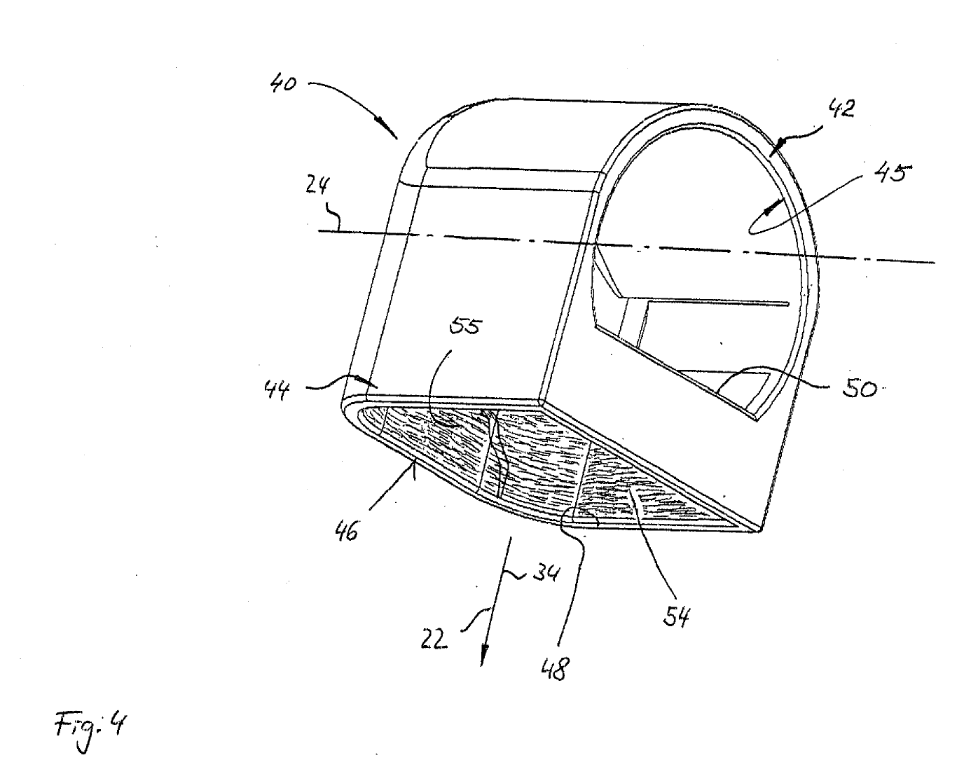

FIG. 4 a perspective representation of a spacer attachment with short overall length;

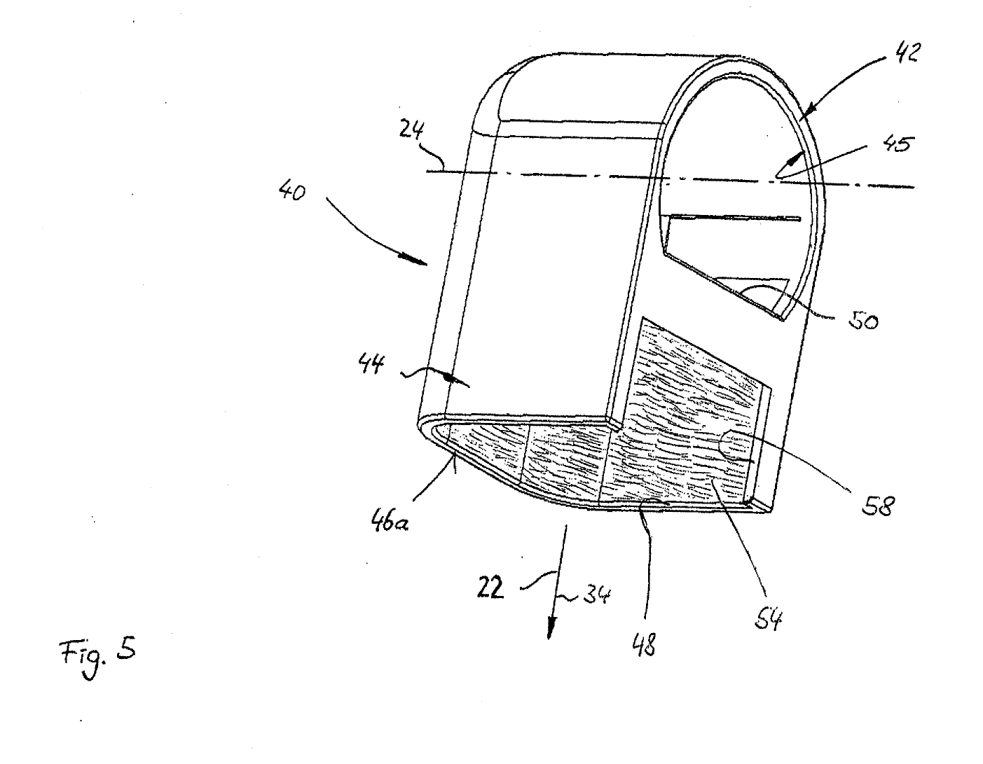

FIG. 5 a perspective representation of a spacer attachment with medium overall length;

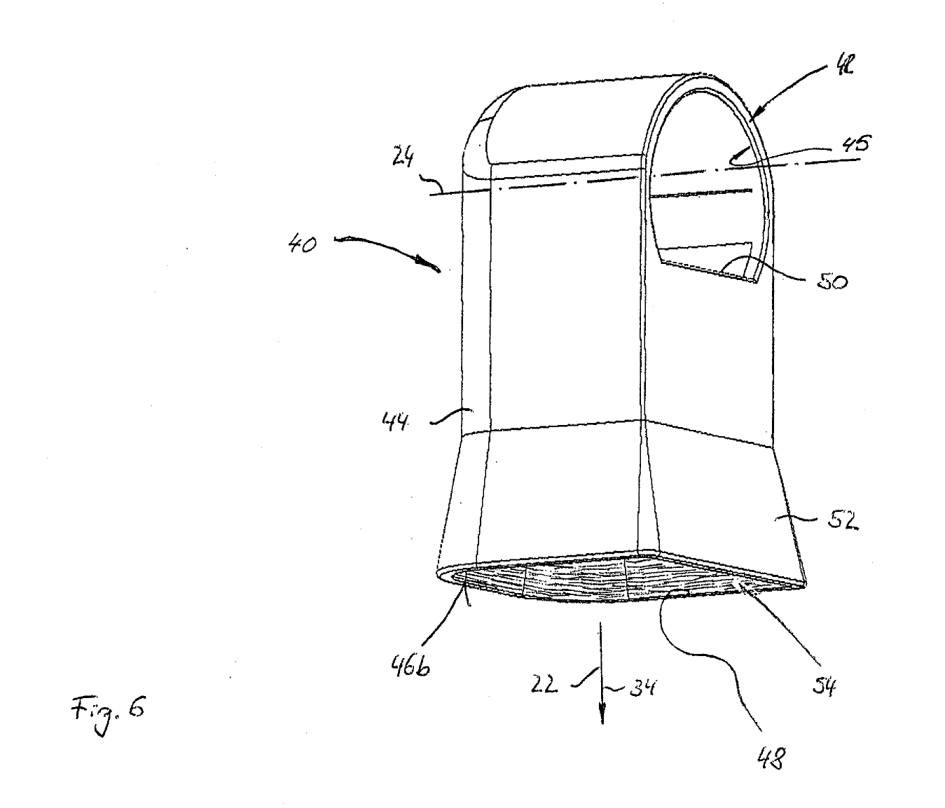

FIG. 6 a perspective representation of a spacer attachment with long overall length and with a pyramidally widened end region; and

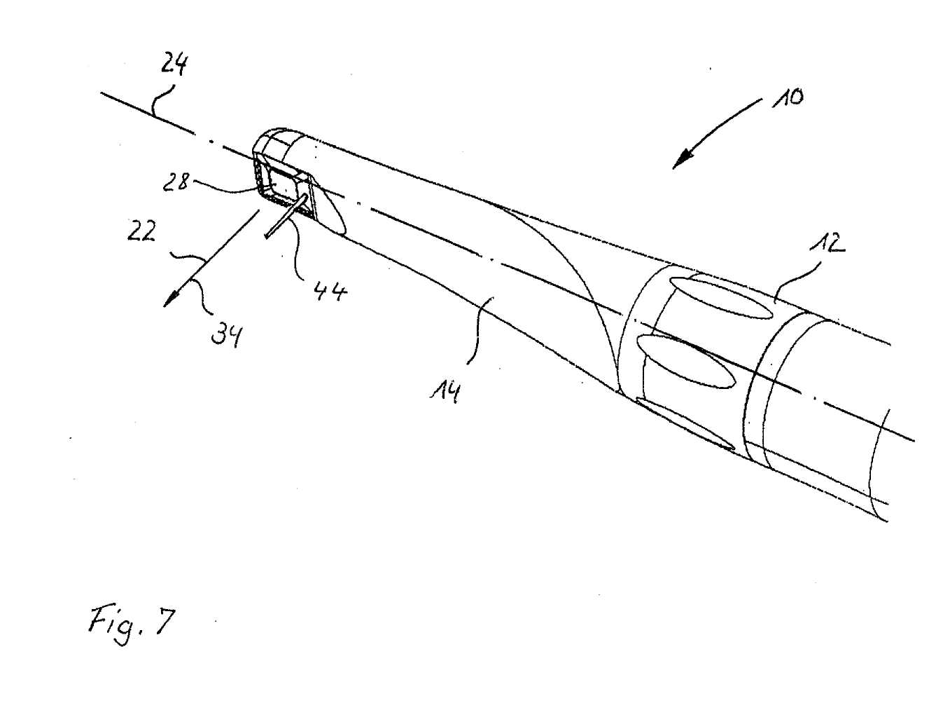

FIG. 7 a side view of a dental diagnostic camera with spacer moulded onto the camera housing.

Represented in FIG. 1 is a dental diagnostic camera 10 which exhibits a gripping portion 12 and a head region 14 designed substantially in the form of a conical portion which is provided in prolongation of the gripping portion 12.

At a rear end of the gripping portion 12 facing away from the head region 14 and not represented, the dental diagnostic camera 10 exhibits a cable, not represented, which is provided for the provision of electrical energy and, in particular, for the communication of the electrical image signals generated by the dental diagnostic camera 10. The image signals are generated by a camera unit 16 integrated within the head region 14.

The camera unit 16 consists substantially, as represented in more detail in FIG. 3, of an optical system 18 and an image-recording device 20. A direction of view 22 of the diagnostic camera 10 is oriented substantially orthogonally relative to a central longitudinal axis 24 of the gripping portion 21 and of the head region 14. As a result, a particularly ergonomic handling of the diagnostic camera 10 is guaranteed, which is also particularly advantageous for the examination of tooth surfaces in the cramped oral space.

According to FIG. 2, an attachment 40 is attached onto the diagnostic camera 10, which attachment facilitates compliance with a defined spacing between the diagnostic camera and the object to be examined and which will be described in more detail below on the basis of several exemplary embodiments.

As represented in more detail in the sectional representation shown in FIG. 3, rays of light emanating from an illuminated object 41, for example from a tooth in an oral space of a patient, are projected onto an image-recording device 20 by means of the optical system 18. The image-recording device 20 is, for example, a CCD (charge-coupled device) and exhibits a photosensitive sensor surface which effects, pixel by pixel, a conversion of radiated rays of light into electrical signals.

The electrical output signals of the image-recording device 20 are then passed via the cable, which is not represented, to an image-processing unit, likewise not represented, which controls the representation of the object 41 on a monitor.

The optical system 18 exhibits a transparent window 28 inserted tightly into the wall of the head region 16, a deflecting mirror 26, and a lens system 30 with two lenses 31, 33. The transparent window 28 is tightly glued into the head region 14, in order to be able to accommodate the camera unit 16 in moisture-proof manner in the sleeve-shaped head region 14 forming a part of the camera housing.

The deflecting mirror 26 brings about a 90-degree deflection of the rays of light, i.e. of the object rays emanating from the object 41. A ray of light emanating from the object 41 which is considered in exemplary manner can, after deflection by the deflecting mirror 26, run parallel to the central longitudinal axis 24 and impinges perpendicularly on the sensor surface of the image-recording device 20. The direction of view 22 of the camera unit 16 is consequently oriented orthogonally relative to the central longitudinal axis 24 of the diagnostic camera 10 by the action of the deflecting mirror 26.

The angle of coverage y which is capable of being registered by the image-recording device 20 is substantially determined by the lens system 30. In addition, the lens system 30 determines a depth-of-field region or object region 36 within which an object is sharply imaged onto the image-recording device 20.

Within the object region 36 an object plane 38 characterises that plane in which an object is imaged in maximally sharp manner. The angle of coverage γ can, where appropriate, be limited by the size of the window 28, by the size of the deflecting mirror 26, or by a field stop, not represented, provided in the optical ray path or also by the attachment 40.

Adjacent to the deflecting mirror 26 a light-source 32 constructed as a white-light LED is provided which serves for illumination of the object to be imaged. The principal direction of radiation 34 of the light-source 32 runs at least substantially parallel to the direction of view 22 of the camera unit 16.

The attachment 40 shown in the sectional representation of FIG. 3 is pushed onto the end of the head region 14 of the diagnostic camera 10 and is retained on the head region 14 by forced closure and also positively.

The attachment 40 produced from a sterilisable plastic, for example polypropylene, exhibits a coupling portion 42 designed as connection means and also a spacer portion 44. As represented in more detail in FIGS. 4 to 6, wall portions of the coupling portion 42 and the spacer portion 44 delimit an opening 45, into which the head region 16 can be introduced in positive manner.

The coupling portion 42 and the spacer portion 44 are both sleeve-shaped and together form a right-angled channel.

The length of the channel in the direction of the central longitudinal axis 24 is really short in the embodiments of the attachment 40 according to FIGS. 3 to 6 which are represented. In a further embodiment of the invention which is not represented, the channel may also be significantly longer in the region of the coupling portion, in order to achieve a greater axial overlap with the head region 16.

The coupling portion 42 is matched to the cross-section of the head region as regards the cross-section of the opening 45 in such a manner that a force-closed coupling of the attachment 40 to the head region 14 is obtained. To this end, the free inner cross-section of the coupling portion 42 is chosen to be slightly smaller than the outer cross-section of the head region 14, so that when the attachment 40 is placed onto the head region 14 an elastic deformation of the coupling portion 42 occurs. This elastic deformation provides the frictional force necessary for the desired force-closed fixing of the attachment 40 to the diagnostic camera 10.

In addition, the coupling portion 42 is provided with an inward-projecting detent lug 56 which engages elastically in a groove provided in the head region 14 and in this way guarantees a reliable latching of the attachment 40 on the diagnostic camera 10.

The spacer portion 44 designed in the form of a sleeve exhibits a free end portion 46 projecting beyond the window 28 in the direction of view 22 of the camera unit 16, which terminates in the object plane 38 and is at least closely adjacent to the latter.

Hence the free end portion 46 indicates to the user how closely the diagnostic camera 10 has to be advanced towards the object 41 in order to provide a sharp image. If the free end portion 46 is placed onto a surface of an object 41, the object surface is automatically situated within the object region 36 of the diagnostic camera 10.

By virtue of the contiguity of the free end portion 46 on the object surface, in addition an attitude stabilisation of the diagnostic camera 10 is ensured. This facilitates, on the one hand, the choice of the correct image detail. On the other hand, jittering movements of the user, which could arise without a placement of the free end portion 46 onto the object, are reduced or entirely avoided. Hence the image recorded by the diagnostic camera 10 is still and stable.

The attachment 40 represented in FIG. 4 exhibits a box-like structure. A side wall of the attachment 40 is completely recessed, as a result of which a viewing window 48 bordered by the sleeve-shaped free end portion 46 is formed. On a side wall of the attachment 40 adjacent to the viewing window 48 the opening 45 serving for coupling purposes is provided, which exhibits a substantially circular edge contour with a flat region 50 oriented parallel to the end face of the end portion 46.

In the case of the attachment 40 according to FIG. 4, the free end portion 46 is arranged approximately 5 mm away from the flat region 50, so that the spacing between the object 41 and the window 28 likewise amounts to approximately 5 mm and the free end portion 46 is situated at least almost in the object plane 38.

On an inner face of the attachment 40 a full-perimeter roughened surface 54 is provided in the region of the spacer portion 44. The roughening can be achieved, for example, by a surface treatment provided in the injection mould for the attachment 40, for example by sandblasting, and is moulded onto the attachment 40 in the course of the injection process.

The roughened surface 54 has the effect that rays of light emanating from the light-source 32 or from the object are diffusely scattered on the inner surface of the spacer portion 44. Consequently these rays of light cannot be scattered into the optical system 18 of the camera unit 16 in unhindered manner as rays of stray light, as a result of which an improvement of the image quality of the diagnostic camera 10 can be realised.

Alternatively, the inner face of the spacer portion 44 may be constructed to be light-absorbing, in particular black, for example it may be lacquered black.

By virtue of the geometry of the attachment 40 which is matched to the angle of coverage of the camera unit, in addition a lateral escape of rays of light that were radiated by the light-source 32 is reduced or prevented. Hence more light is available for the illumination of the object, as a result of which a further contribution for an improved image quality is obtained.

In the case of the attachment 40 represented in FIG. 5, wherein for functionally identical elements the reference symbols already introduced are retained, the free end portion 46 is arranged about 10 mm away from the flat region 50 and is partly interrupted by a recess 58.

Hence in the course of placing the diagnostic camera 10 provided with the attachment 40 onto an uneven surface it can be guaranteed that object regions protruding from the uneven surface, which are to be represented by means of the diagnostic camera 10, come to be situated in the object plane 38 or at least in the object region 36 of the diagnostic camera 10.

In addition, the recess 58, which faces towards the user of the diagnostic camera 10, makes possible a direct view of the surface to be recorded.

In the case of the attachment 40 represented in FIG. 6, wherein for functionally identical elements the reference symbols already introduced have been retained, the free end portion 46 is arranged about 18 mm away from the flat region 50 and is located at the end on an extension 52 of the box-shaped attachment 40 which is designed substantially in the form of a truncated pyramid.

With the design of the extension 52 in the form of a truncated pyramid it can be ensured that the attachment 40 is of compact construction and can be placed in simple manner onto an object to be examined. The aperture angle of the extension 52, accordingly the angle included between the pyramidal faces arranged opposite in the given case, is adapted to the angle of coverage γ of the camera unit 16 in such a manner that marginal rays which can still be registered by the image-recording device 20 run substantially parallel to the pyramidal faces of the extension 52. Hence the attachment 40 does not act as a limit stop for the image recorded by the camera unit 16.

In the exemplary embodiment according to FIG. 7, a spacer bar 44 is moulded onto the head region 16, the axis of which runs perpendicular to the axis of gripping portion 14 and head region 16 and is situated laterally outside the field of view or is closely adjacent to the edge of the field of view.

Alternatively, the spacer bar 44 may be detachably inserted into a recess of the head region 16, which is advantageous with regard to production as well as cleaning and sterilisation of the diagnostic camera.

In this way, the same advantages are obtained as in the exemplary embodiments according to FIGS. 1 to 6.

The diagnostic camera described above may also be used for the purpose of examining other poorly accessible body parts of humans and animals in human medicine or in veterinary medicine. It may also be employed in materials testing and product testing for the purpose of monitoring poorly accessible surface regions.

The free end portion 46 of the spacer 40 can be tightly sealed by a transparent end plate 55, as indicated in FIG. 4. This constitutes an abutment surface for tissue to be examined and in this way provides for a precise positioning of the same in the object plane. At the same time, curvatures of the tissue are prevented. In this way the free end of the spacer is also protected against penetration of contaminants and germs. The smooth outer surface at the end of the spacer 40 facilitates the sterilisation and disinfection thereof.

1. A diagnostic camera for medical and dental purposes, the diagnostic camera having a housing with an optical system and with an image-recording device which is accommodated in the housing, wherein the housing bears a spacer portion on an object side.

2. A diagnostic camera according to claim 1, wherein the spacer portion is arranged on a coupling portion which is detachably arranged on the housing.

3. A diagnostic camera according to claim 1, wherein a free end portion of the spacer portion predetermines a bearing surface which is substantially perpendicular to a direction of view of the optical system.

4. A diagnostic camera according to claim 1, wherein a free end portion of the spacer portion is designed as an at least substantially full-perimeter sleeve which is closed in the peripheral direction.

5. A diagnostic camera according to claim 1, wherein the coupling portion is designed as an at least substantially full-perimeter sleeve which is closed.

6. A diagnostic camera according claim 2, wherein to the spacer portion and the coupling portion are sleeve-shaped and together delimit an uninterrupted channel.

7. A diagnostic camera according to claim 6, wherein at least in the region of the spacer portion the channel is provided on an inner side with a light-absorbing or light-scattering surface.

8. A diagnostic camera according to claim 7, wherein in the region of the spacer portion the channel is provided on the inner side with an increased roughness.

9. A diagnostic camera according to claim 1, wherein the spacer portion widens towards the free end.

10. A diagnostic camera according to claim 2, wherein the coupling portion and the spacer portion are produced integrally in a plastics injection-moulding process.

11. A diagnostic camera according to claim 1, wherein one or more of the spacer portion, parts of a coupling portion integrally connected to the spacer portion, and the housing is/are produced from a sterilisable and/or disinfectable plastic.

12. A diagnostic camera according to claim 2, wherein the coupling portion is matched to a head region of the housing in such a manner that in a pushed-on working position it is positively fixed to the head region.

13. A spacer attachment for a diagnostic camera for medical and dental purposes, the diagnostic camera having a housing, an optical system and an image-recording device accommodated in the housing, wherein the spacer attachment has a spacer portion which is arranged on a coupling portion which can be detachably arranged on the housing.

14. A spacer attachment according to claim 13, wherein a free end portion of the spacer portion predetermines a bearing surface which is substantially perpendicular to a longitudinal axis of the spacer portion.

15. A spacer attachment according to claim 13, wherein a free end portion of the spacer portion is designed as an at least substantially full-perimeter sleeve which is closed in the peripheral direction.

16. A spacer attachment according to claim 13, wherein the coupling portion is designed as an at least substantially full-perimeter sleeve which is closed.

17. A spacer attachment according to claim 14, wherein the spacer portion and the coupling portion are sleeve-shaped and together delimit an uninterrupted channel.

18. A spacer attachment according to claim 17, wherein at least in the region of the spacer portion the channel is provided on an inner side with a light-absorbing or light-scattering surface.

19. A spacer attachment according to claim 18, wherein in the region of the spacer portion the channel is provided on the inner side with grooves.

20. A spacer attachment according to claim 13, wherein the spacer portion widens towards the free end.

21. A spacer attachment according to claim 13, wherein the coupling portion and the spacer portion are produced integrally in a plastics injection-moulding process.

22. A spacer attachment according to claim 13, wherein one or more of the spacer portion, and parts of the coupling portion integrally connected to the spacer portion is/are produced from a sterilisable and/or disinfectable plastic.

23. A spacer attachment according to claim 13, wherein the coupling portion is matched to a head region of the housing in such a manner that in a pushed-on working position it is positively fixed to the head region.

24. A spacer attachment according to claim 14, wherein the free end portion bears a transparent end plate.

25. A spacer attachment according to claim 15, wherein the free end portion has a transparent end plate that is tightly connected to the sleeve.

26. A diagnostic camera according to claim 3, wherein the free end portion bears a transparent end plate.

27. A diagnostic camera according to claim 4, wherein the free end portion has a transparent end plate that is tightly connected to the sleeve.

28. A diagnostic camera according to claim 2, wherein the coupling portion is on a head region of the housing.

29. A diagnostic camera according to claim 6, wherein the channel is angled by 90 degrees.

30. A diagnostic camera according to claim 8, wherein the increased roughness is formed by grooves on the inner side surface of the channel.

31. A diagnostic camera according to claim 9, wherein the spacer portion is conical or pyramid shaped.

32. A diagnostic camera according to claim 1, wherein the sterilisable or disinfectable plastic is polypropylene.

33. A spacer attachment according to claim 13, wherein the coupling portion is on a head region of the housing.

34. A spacer attachment according to claim 7, wherein the channel is angled by 90 degrees.

35. A spacer attachment according to claim 13, wherein the spacer portion is conical or pyramid shaped.

36. A spacer attachment according to claim 24 wherein the transparent end plate is tightly connected to the sleeve.

37. A diagnostic camera according to claim 26, wherein the transparent end plate is tightly connected to the sleeve.
